(19) United States
(12) Patent Application Publication
(10) Pub. No.: US 2020/0233560 A1
(43) Pub. Date: Jul. 23, 2020

(54) MEASUREMENT DEVICE AND METHOD FOR THREE-DIMENSIONAL DISPLAYS

(71) Applicant: Rohde & Schwarz GmbH & Co. KG, Munich (DE)

(72) Inventor: Andreas LAGLER, Rosenheim (DE)

(21) Appl. No.: 16/252,762

(22) Filed: Jan. 21, 2019

(51) Int. Cl. G06F 3/0481; G06T 11/20; G06F 3/0488; G06F 3/0484

(52) U.S. Cl. CPC G06F 3/04815; G06T 11/206; G06F 2203/04804; G06F 3/04847; G06F 3/0488

(57) ABSTRACT

A measurement device and a method for data visualization and three-dimensional display are provided. The measurement device comprises a measuring unit, a memory, storing measurement results measured by the measuring unit and which are a function of at least two different measurement parameters, a processor and a display. The processor is configured to create a three-dimensional, 3D, graph of the measurement results stored in the memory, and to automatically compute, on the basis of at least one point of interest in the form of a data marker, two cross-sections of the 3D graph along different planes, whereby one of the sides of each cross-section terminates at the surface of the 3D graph and includes the position of the at least one data marker. The display displays the 3D graph of the measurement results, the at least one data marker and at least one of the cross-sections of the 3D graph associated with the at least one data marker.

### FIELD OF THE INVENTION

The present invention relates to a measurement device and a method for visualizing and displaying measurement results in a three-dimensional graph. More specifically, one of the major but not limitative scope of application of the invention is the field of electronic measurement devices.

### BACKGROUND OF THE INVENTION

In conventional measuring devices, a display of a variety of information related to the actual measurement is provided on a display. Furthermore, a plurality of measurement results which depend on several parameters related with the measurement can be available. The display and visualization of such a plurality of multi-variable measurement results is frequently achieved in the form of three-dimensional graphs.

For instance, in U.S. Pat. No. 6,484,048 B1, an easily recognized spatial relationship between an object being scanned and a section thereof is displayed (together with a real time image of the section) to enable quick, easy and accurate selection of a desired three-dimensional position for the section. In addition to sequentially pasted real time section images, a reference image acquired at an arbitrary time may also be pasted on a portion of the display, enabling a spatial understanding of the position of the section being scanned and imaged. Said sections are depicted as superimposed slices containing the imaging results.

However, the overall topology inherent to the measurement results may hinder the visibility and identification of specific points or markers, which are of particular interest for a user.

There is the need, thus, to provide a measurement device and a method for displaying measurement results in a three-dimensional graph which allows the unambiguous visualization of the position of at least one point of interest in the form of data marker relative to the features of the three-dimensional graph, in an automatic, efficient and time-saving manner.

It is mentioned that the term 3D is used hereinafter to refer to three dimensions or three-dimensional.

### SUMMARY OF THE INVENTION

According to a first aspect of the invention, a measurement device for data visualization and three-dimensional display is provided. The measurement device comprises a measuring unit; a memory, storing measurement results measured by the measuring unit and which are a function of at least two different measurement parameters; a processor, configured to create a three-dimensional (3D) graph of the measurement results stored in the memory, and to automatically compute, on the basis of at least one point of interest in the form of a data marker, two cross-sections of the 3D graph along different planes, whereby one of the sides of each cross-section terminates at the surface of the 3D graph and includes the position of the at least one data marker; and a display, displaying the 3D graph of the measurement results, the at least one data marker and at least one of the cross-sections of the 3D graph associated with the at least one data marker. Advantageously, unambiguous visualization of data markers and the profile associated with the measurement can be achieved in an accurate, efficient and prompt manner.

According to a first preferred implementation form of the first aspect, the at least one point of interest in the form of a data marker is determined on the basis of at least one user input set through an input unit. Advantageously, specific user preferences are allowed.

According to a second preferred implementation form of the first aspect, the at least one user input comprises selecting at least one point of interest on the 3D graph displayed on a touch display. In addition to this or alternatively, the at least one user input comprises entering two parameters of interest through an input device. Advantageously, a variety of user input capabilities adapted to the respective user case is provided.

According to a further preferred implementation form of the first aspect, the display displays at least portions of at least one of the cross-sections, preferably each of the cross-sections, in the 3D graph. Advantageously, accuracy and efficiency are increased.

According to a further preferred implementation form of the first aspect, the intersection of each of the cross-sections with the 3D graph is displayed by the display, whereby the intersection corresponds to the position of the at least one data marker. Advantageously, the profile associated with the measurement is visually available for the user. Further advantageously, speed and efficiency are enhanced.

According to a further preferred implementation form of the first aspect, the display unit displays the 3D graph, additionally or alternatively at least one of the cross-sections, preferably each of the cross-sections, with some transparency to allow simultaneous display. In this manner, improved visibility of the position of the data marker relative to the features of the 3D graph is achieved. Advantageously, accuracy and efficiency are further increased.

According to a further preferred implementation form of the first aspect, the display removes the 3D graph and displays at least one of the cross-sections, preferably each of the cross-sections, associated with the at least one data marker, based upon at least one user input received through an input unit. Advantageously, data visualization is enhanced.

According to a further preferred implementation form of the first aspect, the display is configured to display multiple points of interest in the form of data markers, determined on the basis of multiple user inputs, and at least one of two cross-sections associated with each one of the multiple data markers, whereby the cross-sections are automatically computed by the processor and wherein one of the sides of each cross-section terminates at the surface of the 3D graph. Advantageously, efficiency and accuracy are increased.

According to a further preferred implementation form of the first aspect, the display displays the 3D graph and/or at least one of the cross-sections, preferably each of the cross-sections, by assigning different transparent values, additionally or alternatively transparent colors, to a particular cross-section or to the 3D graph. Advantageously, accuracy and efficiency are further enhanced.

According to a second aspect of the invention, a method for data visualization and three-dimensional display of measurement results is provided. The method comprises the steps of creating a three-dimensional (3D) graph of measurement results, measured by a measuring equipment and stored in a memory, which are a function of at least two different data parameters; automatically computing two cross-sections of the 3D graph along different planes on the basis of at least one point of interest in the form of a data marker, whereby one of the sides of each cross-section terminates at the surface of the 3D graph and includes the position of the at least one data marker; and displaying, in a display, the 3D graph of the measurement results, the at least one data marker and at least one of the cross-sections associated with the at least one data marker. Advantageously, unambiguous visualization of data markers and the profile associated with the measurement can be achieved in an accurate, efficient and prompt manner.

According to a first preferred implementation form of the second aspect, the at least one point of interest in the form of a data marker is determined on the basis of at least one user input set through an input unit. Advantageously, specific user preferences are allowed.

According to a second preferred implementation form of the second aspect, the at least one user input comprises selecting at least one point of interest on the 3D graph displayed on a touch display. In addition to this or alternatively, the at least one user input comprises entering two parameters of interest through an input device. Advantageously, a variety of user input capabilities adapted to the respective user case is provided.

According to a further preferred implementation form of the second aspect, the method further comprises displaying at least portions of at least one of the cross-sections, preferably each of the cross-sections, on the display. Advantageously, accuracy and efficiency are increased.

According to a further preferred implementation form of the second aspect, the method further comprises the step of displaying, on a display, the intersection of each of the cross-sections with the 3D graph, whereby the intersection corresponds to the position of the at least one data marker. Advantageously, the profile associated with the measurement is visually available for the user. Further advantageously, speed and efficiency are enhanced.

According to a further preferred implementation form of the second aspect, the method further comprises the step of displaying, in a display, the 3D graph and additionally or alternatively at least one of the cross-sections, preferably each of the cross-sections, with some transparency to allow simultaneous display. In this manner, improved visibility of the position of the data marker relative to the features of the 3D graph is achieved. Advantageously, accuracy and efficiency are further increased.

According to a further preferred implementation form of the second aspect, the method further comprises the optional step of removing the 3D graph and displaying at least one of the cross-sections, preferably each of the cross-sections, associated with the at least one data marker, based upon a user input. Advantageously, data visualization is enhanced.

According to a further preferred implementation form of the second aspect, the method further comprises the step of displaying multiple points of interest in the form of data markers, based upon user inputs, and at least one of two cross-sections associated with each one of the multiple data markers, wherein the cross-sections are automatically computed by a processor and wherein one of the sides of each cross-section terminates at the surface of the 3D graph and includes the position of the associated data marker. Advantageously, efficiency and accuracy are increased.

According to a further preferred implementation form of the second aspect, the method further comprises the steps of displaying the 3D graph and/or at least one of the cross-sections, preferably each of the cross-sections, by assigning different transparent values, additionally or alternatively or transparent colors, to a particular cross-section or to the 3D graph. Advantageously, accuracy and efficiency are further enhanced.

### BRIEF DESCRIPTION OF THE DRAWINGS

Illustrative embodiments of the invention are further explained by way of example, and not for limitation, with respect to the accompanying drawings in which like reference numerals refer to similar elements. In the drawings:

FIG. 1A shows a block diagram of a first exemplary embodiment of a measurement device according to the first aspect of the invention;

FIG. 1B shows a block diagram of a second embodiment of a measurement device in accordance with the present invention;

FIG. 2A shows an exemplary three-dimensional display of measurement results including a three-dimensional graph and a data marker, in accordance with the present invention;

FIG. 2B shows an exemplary three-dimensional display of measurement results including a data marker and two cross-sections associated with the data marker;

FIG. 2C shows an exemplary three-dimensional display of measurement results including two data markers and cross-sections associated with each one of the data markers; and

FIG. 3 shows a flow chart of a representative embodiment of a method for data visualization in three-dimensions according to the second aspect of the invention.

### DETAILED DESCRIPTION OF THE INVENTION

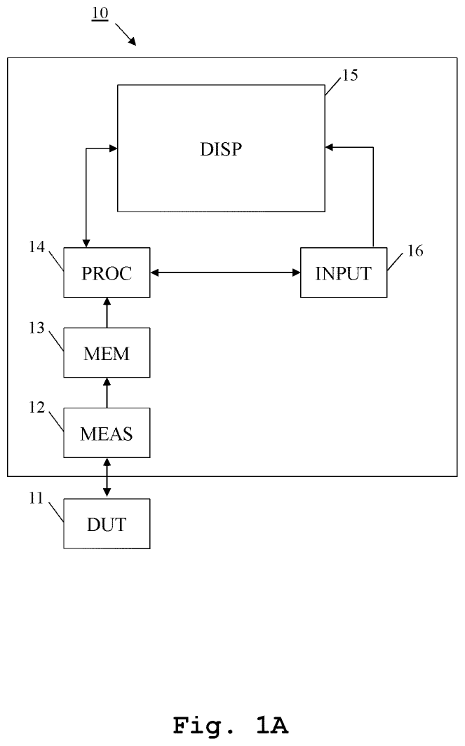

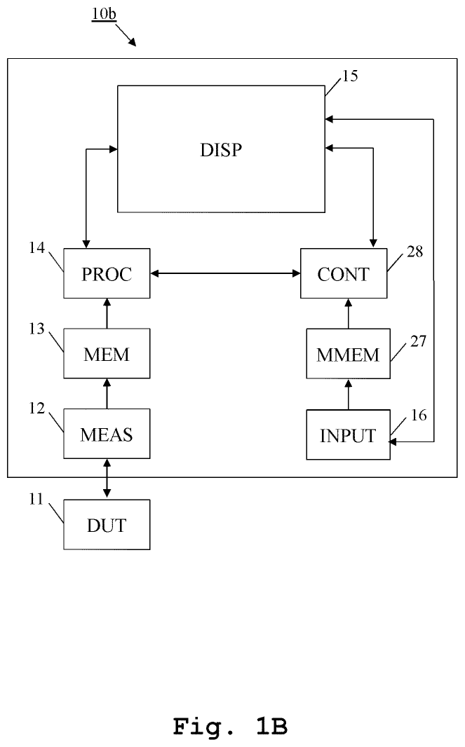

FIG. 1A illustrates a first exemplary embodiment of the inventive measurement device 10 according to the first aspect of the invention. Said measurement device 10 comprises a measuring unit 12 which is connected to a memory 13. The memory 13 is connected to a processor 14, which in turn is connected to a display 15.

In this exemplary case, the measurement device 10 is connected, by the measuring unit 12, to a device under test 11. The device under test 11 can be, for example, a spectrum analyzer, an oscilloscope, a signal generator, a signal analyzer, a network analyzer, etc.

In this context, the measuring unit 12 performs measurements on the device under test 11. The measurement results, which are a function of at least two different measurement parameters, are stored in the memory 13 along with the corresponding measurement parameters and are further supplied to the processor 14. Then, the processor 14 creates a 3D graph of the measurement results, which is displayed by the display 15.

It should be mentioned that in the 3D graph the coordinates x and y correspond to at least two measurement parameters related to the measuring unit 12, and the z coordinate corresponds to a measurement result. Therefore, each measurement result corresponds to a point in the 3D graph with coordinates (x,y,z), and the measurement results are located on the surface of the 3D graph.

Furthermore, at least one point of interest in the form of a data marker in the 3D graph is determined on the basis of at least one user input set through an input unit 16. The at least one data marker is supplied, with the aid of the input unit 16, to the processor 14.

In this context, the display 15 may contain a touch-sensitive screen. In this case, the display 15 may be embodied to detect the at least one user input performed by selecting a point of interest on the 3D graph displayed on a touch display. Additionally or alternatively, the at least one user input is performed by entering, through the input unit 16, at least two parameters of interest, exemplary in the form of two coordinates x and y, or x and z or a combination thereof.

Next, the processor 14 automatically computes, on the basis of the at least one data marker, two cross-sections of the 3D graph along different coordinate planes, whereby one of the sides of each cross-section terminates at the surface of the 3D graph and includes the position of the at least one data marker.

Moreover, the display 15 displays the 3D graph of the measurement results, the at least one data marker and at least one of the cross-sections, preferably each of the cross-sections associated with the at least one data marker and computed by the processor 14.

Also, the display 15 may be configured to display at least portions of at least one of the cross-sections, preferably each of the cross-sections, on the display.

In the context of FIG. 1A, especially, it is mentioned that the intersection of each of the cross-sections with the 3D graph is displayed by the display 15, whereby the intersection corresponds to the position of the at least one data marker. Said intersection can be displayed, for example, as the termination of the cross-sections, or as a line along at least one of the cross-sections. Advantageously, this enables the unambiguous visualization of the at least one data marker with respect to the topology of the 3D graph.

Furthermore, the display 15 is embodied to display the 3D graph and additionally or alternatively at least one of the cross-sections, preferably each of the cross-sections, with some transparency to allow simultaneous display.

In addition to this, the display 15 may remove the 3D graph and display only at least one of the cross-sections, preferably each of the cross-sections, associated with the at least one data marker, based upon at least one user input that is received through the input unit 16. In this manner, visualization of the profile associated with the measurement in the three dimensions is achieved.

Moreover, the display 15 displays multiple points of interest in the form of data markers, on the basis of user inputs set through the input unit 16, and at least one of the two cross-sections associated to each one of the multiple data markers, whereby the cross-sections are automatically computed by the processor 14 and wherein one of the sides of each cross-section terminates at the surface of the 3D graph.

In order to provide the most complete display of the measurement results to the user, the display 15 displays the 3D graph and additionally or alternatively at least one of the cross-sections, preferably each of the cross-sections, by automatically assigning different transparent values and/or different transparent colors to a particular cross-section, additionally or alternatively to the 3D graph.

By way of example, a cross-section is displayed on the display 15 in a transparent fashion if it covers at least one portion of another cross-section located at the back of the 3D graph; however, transparency is not assigned to the first of said cross-sections if it does not cover the at least one portion of a cross-section at the back, but the cross-sections are displayed with different colors in order to distinguish them. As a further example, different cross-sections can be assigned with different transparent colors, or alternatively with different transparency values.

By way of further example, the display 15 may be configured to display at least one of the cross-sections or the 3D graph in a transparent fashion to allow visibility of the details of at least one of the coordinate axes. Instead, the at least one cross-section can be assigned with a specific color to cover at least one of the coordinate axes.

FIG. 1B depicts a second exemplary embodiment of the inventive measurement device 10b, which further comprises a marker memory 27 and a control unit 28. As explained before, a processor 14 generates a 3D graph of measurement results, measured by a measuring unit 12 and stored in a memory 13, which is displayed by a display 15.

Furthermore, the marker memory 27 is connected to an input unit 16 and to the control unit 28, and is configured to store at least one user input determining at least one point of interest in the form of at least one data marker in the 3D graph. The control unit 28 receives the at least one data marker from the memory marker 27, and subsequently supplies it to the processing unit 14.

After receiving the at least one data marker, the processing unit 14 automatically computes two cross-sections of the 3D graph along different coordinate planes, whereby one of the sides of each cross-section terminates at the surface of the 3D graph and includes the position of the at least one data marker.

Then, the 3D graph of the measurement results, including the at least one data marker and at least one of the cross-section associated with the at least one data marker, are displayed by the display 15, which in turn is also connected to the controlling unit 28.

Moreover, the control unit 28 is configured to control the processor 14 and the display 15 on the basis of user inputs received through the input device 16. In this embodiment, thus, further control of data visualization and 3D display is achieved.

In addition to the explanations above, the invention should especially be discussed with respect to the following exemplary case:

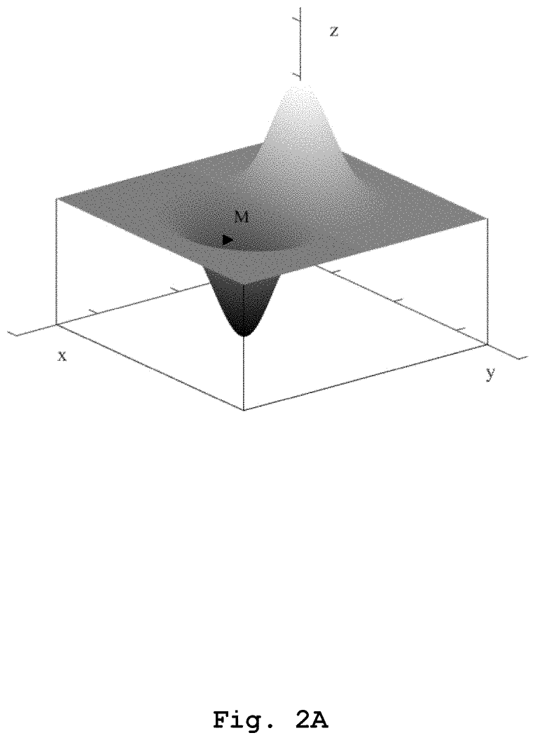

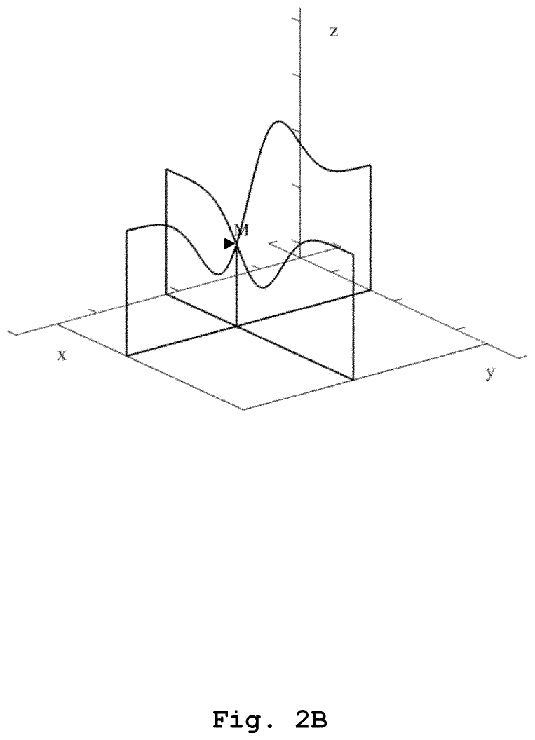

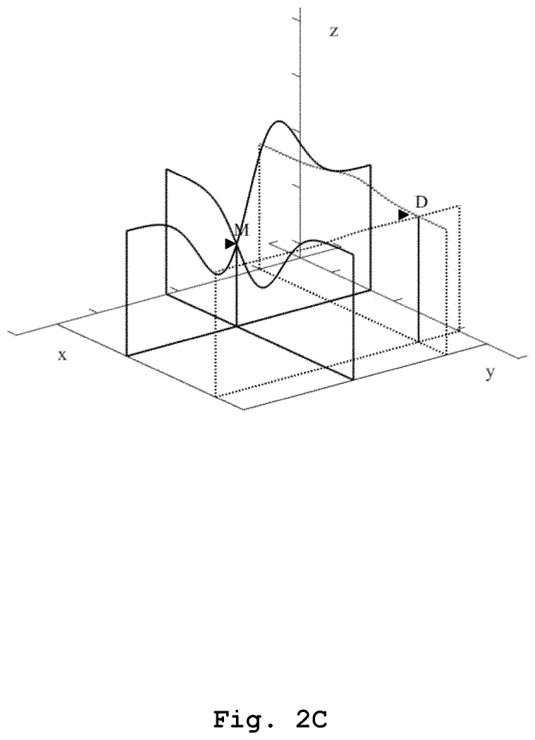

FIG. 2A illustrates an exemplary 3D graph of measurement results, including a data marker M determined by at least one user input, as displayed by the display 15. With respect to FIG. 2A, it is mentioned that the topology exhibited by the measurement results can have local maxima and local minima.

Next, in FIG. 2B, the 3D graph has been removed and the display 15 displays two cross-sections associated to the data marker M and computed by the processor 14. In this particular example, it is noted that one of the cross-sections is parallel to the coordinate xz plane while the other cross-section is parallel to the coordinate yz plane. It is emphasized that, additionally or alternatively, cross-sections that are nonparallel to the coordinate axes can also be computed by the processor 14, and displayed by the display 15.

By way of example, in the case that the device under test 11 is a spectrum analyzer, the cross-section parallel to the xz plane in FIG. 2B may correspond to a spectrum that is dropped to the zero-magnitude point for the display, and the cross-section parallel to the yz plane is the interpolated graph of the measurement results at a particular frequency, computed over several measurement cycles. In this context, the user input determining the data marker M can be set in the form of a selected frequency and time for the measurement.

From FIG. 2B it can be seen that the intersection of the cross-sections occur at the position of the data marker M. Furthermore, the cross-sections terminate at the surface of the 3D graph, and reveal the profile associated with the measurement, performed by the measuring unit 12, in each direction x, y and z.

In FIG. 2C, the display 15 displays two different data markers M and D determined on the basis of user inputs and located at the intersection of their corresponding cross-sections. Furthermore, the cross-sections are exemplary displayed in a transparent fashion to allow the visualization of the coordinate axes.

The exemplary displays shown in FIG. 2B and FIG. 2C, thus, illustrate the advantageous features of the inventive measurement device.

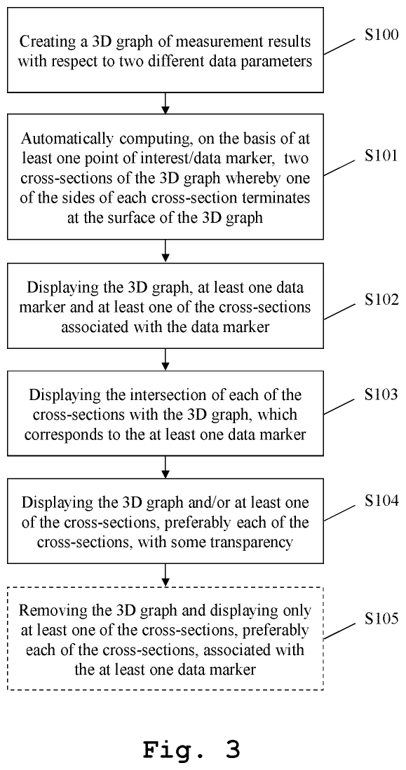

Now, FIG. 3 shows a flow chart of an embodiment of the method according to the second aspect of the invention. In a first step S100, a three-dimensional graph of measurement results, measured by a measuring unit and stored in a memory, which are a function of at least two different measurement parameters, is created by a processor.

In a second step S101, two cross-sections of the 3D graph along different coordinate planes are automatically computed by the processor on the basis of at least one point of interest in the form of at least one data marker in the 3D graph, whereby one of the sides of each cross-section terminates at the surface of the 3D graph and includes the position of the at least one data marker.

In this context, the at least one user input determining the at least one data marker may comprise selecting at least one point of interest on the 3D graph displayed on a touch display. In addition to this or alternatively, the at least one user input is performed by entering through an input unit at least two parameters of interest, exemplary in the form of two coordinates x and y, or x and z or a combination thereof. As explained before, the coordinates x and y in the 3D graph correspond to at least two measurement parameters related to a measuring unit, and the z coordinate corresponds to a measurement result.

In a third step S102, the 3D graph of the measurement results including the at least one data marker and at least one of the cross-sections associated with the data marker is displayed on a display.

It may be further advantageous that the method comprises displaying at least portions of at least one of the cross-sections, preferably each of the cross-sections, on the display.

Furthermore, the inventive method comprises the step S103 of displaying, on the display, the intersection of each of the cross-sections with the 3D graph, whereby the intersection corresponds to the position of the at least one data marker.

The inventive method further comprises the step S104 of displaying on the display the 3D graph, additionally or alternatively at least one of the cross-sections, preferably each of the cross-sections, with some transparency to allow simultaneous display.

As an optional step S105, the method comprises removing the 3D graph and displaying only at least one of the cross-sections, preferably each of the cross-sections, associated with the at least one data marker based upon a user input.

The inventive method may further comprise displaying on the display multiple points of interest in the form of data markers, based upon user inputs, and at least one of the two cross-sections associated with each one of the multiple data markers, wherein the cross-sections are automatically computed by the processor and wherein one of the sides of the cross-sections terminates at the surface of the 3D graph.

As a further optional step, the inventive method may comprise displaying on the display the 3D graph and additionally or alternatively at least one of the cross-sections, preferably each of the cross-sections, by assigning different transparent values, additionally or alternatively different transparent colors, to a particular cross-section or to the 3D graph.

While various embodiments of the present invention have been described above, it should be understood that they have been presented by way of example only, and not limitation. Numerous changes to the disclosed embodiments can be made in accordance with the disclosure herein without departing from the scope of the invention. Thus, the breadth and scope of the present invention should not be limited by any of the above described embodiments. Rather, the scope of the invention should be defined in accordance with the appended claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A measurement device for data visualization and three-dimensional display, the measurement device comprising:
a measuring unit;
a memory, storing measurement results measured by the measuring unit and which are a function of at least two different measurement parameters;
a processor, configured to create a three-dimensional, 3D, graph of the measurement results stored in the memory, and to automatically compute, on the basis of at least one point of interest in the form of a data marker, two cross-sections of the 3D graph along different planes, whereby one of the sides of each cross-section terminates at the surface of the 3D graph and includes the position of the at least one data marker; and
a display, displaying the 3D graph of the measurement results, the at least one data marker and at least one of the cross-sections of the 3D graph associated with the at least one data marker.

2. The measurement device according to claim 1,
wherein the at least one point of interest in the form of a data marker is determined on the basis of at least one user input set through an input unit.

3. The measurement device according to claim 2,
wherein the at least one user input comprises selecting one point of interest on the 3D graph displayed on a touch display and/or entering two parameters of interest through an input device.

4. The measurement device according to claim 1,
wherein the display displays at least portions of at least one of the cross-sections, preferably each of the cross-sections, in the 3D graph.

5. The measurement device according to claim 1,
wherein the intersection of each of the cross-sections with the 3D graph is displayed by the display, whereby the intersection corresponds to the position of the at least one data marker.

6. The measurement device according to claim 1,
wherein the display displays the 3D graph and/or at least one of the cross-sections, preferably each of the cross-sections, with some transparency to allow simultaneous display.

7. The measurement device according to claim 1,
wherein the display removes the 3D graph and displays at least one of the cross-sections, preferably each of the cross-sections, associated with the at least one data marker based upon at least one user input set through an input unit.

8. The measurement device according to claim 1,
wherein the display is configured to display multiple points of interest in the form of data markers, determined on the basis of multiple user inputs, and at least one of two cross-sections associated with each one of the multiple data markers, whereby the cross-sections are automatically computed by the processor and wherein one of the sides of each cross-section terminates at the surface of the 3D graph.

9. The measuring device according to claim 1,
wherein the display displays the 3D graph and/or at least one of the cross-sections, preferably each of the cross-sections, by assigning different transparent values and/or transparent colors to a particular cross-section and/or to the 3D graph.

10. A method for data visualization and three-dimensional display, the method comprising the steps of:
creating a three-dimensional, 3D, graph of measurement results, measured by a measuring equipment and stored in a memory, which are a function of at least two different data parameters;
automatically computing two cross-sections of the 3D graph along different planes on the basis of at least one point of interest in the form of a data marker, whereby one of the sides of each cross-section terminates at the surface of the 3D graph and includes the position of the at least one data marker; and
displaying, in a display, the 3D graph of the measurement results, the at least one data marker and at least one of the cross-sections associated with the at least one data marker.

11. The method according to claim 10,
wherein the at least one point of interest in the form of a data marker is determined on the basis of at least one user input set through an input unit.

12. The method according to claim 11,
wherein the at least one user input comprises selecting at least one point of interest on the 3D graph displayed on a touch display and/or entering two parameters of interest through an input device.

13. The method according to claim 10,
wherein the method further comprises displaying at least portions of at least one of the cross-sections, preferably each of the cross-sections, on the display.

14. The method according to claim 10,
wherein the method further comprises the step of displaying, on a display, the intersection of each of the cross-sections with the 3D graph, whereby the intersection corresponds to the position of the at least one data marker.

15. The method according to claim 10,
wherein the method further comprises the step of displaying, in a display, the 3D graph and/or at least one of the cross-sections, preferably each of the cross-sections, with some transparency to allow simultaneous display.

16. The method according to claim 10,
wherein the method further comprises the optional step of removing the 3D graph and displaying at least one of the cross-sections, preferably each of the cross-sections, associated with the at least one data marker based upon at least one user input set through an input unit.

17. The method according to claim 10,
wherein the method further comprises the step of displaying multiple points of interest in the form of data markers, based upon user inputs, and at least one of two cross-sections associated with each one of the multiple data markers, wherein the cross-sections are automatically computed by a processor and wherein one of the sides of each cross-section terminates at the surface of the 3D graph and includes the position of the associated data marker.

18. The method according to claim 10,
wherein the method further comprises the steps of displaying the 3D graph and/or at least one of the cross-sections, preferably each of the cross-sections, by assigning different transparent values and/or transparent colors to a particular cross-section and/or to the 3D graph.
